(19) United States
(12) Patent Application Publication
(10) Pub. No.: US 2014/0162585 A1
(43) Pub. Date: Jun. 12, 2014

(54) DYNAMIC SPECTRUM TRADING USING INTERFERENCE PROFILING

(71) Applicants: Tamal Bose, Tucson, AZ (US); Haris Volos, Tucson, AZ (US); Garrett Vanhoy, Tucson, AZ (US); Carlos E. Caicedo Bastidas, Syracuse, NY (US)

(72) Inventors: Tamal Bose, Tucson, AZ (US); Haris Volos, Tucson, AZ (US); Garrett Vanhoy, Tucson, AZ (US); Carlos E. Caicedo Bastidas, Syracuse, NY (US)

(73) Assignees: Syracuse University, Syracuse, NY (US); The Arizona Board of Regents on Behalf of the University of Arizon, Tucson, AZ (US)

(21) Appl. No.: 14/092,835

(22) Filed: Nov. 27, 2013

Related U.S. Application Data
(60) Provisional application No. 61/797,045, filed on Nov. 28, 2012.

(51) Int. Cl. H04W 72/04; H04W 4/22

(52) U.S. Cl. CPC H04W 72/0453; H04W 4/22
USPC 455/404.1; 455/452.1

(57) ABSTRACT

A system and related methods for allowing for an increase in the use of spectrum resources through market based mechanisms for spectrum management. Spectrum trading mechanisms are implemented that allow for assignment and allocation decisions to be made by market forces. The system helps moderate an environment where buyers and sellers dynamically determine the assignment of spectrum and its uses.

### CROSS-REFERENCE TO RELATED APPLICATIONS

The present application claims the priority benefit of U.S. provisional application No. 61/797,045 filed Nov. 28, 2012 and entitled “Quality of Service Based Dynamic Spectrum Assignment System,” the disclosure of which is incorporated herein by reference.

### BACKGROUND

1. Field of the Invention

The present invention generally concerns wireless communication services and the radio frequency (RF) spectrum. The present invention more specifically concerns utilizing market-based approaches to promote the efficient use of RF spectrum.

2. Description of the Related Art

The evolution of technologies that enhance the delivery of wireless communication services has driven the growth of many device and wireless service provider markets. Critical to the delivery of these communication services is the use of RF signals from the RF spectrum.

Frequencies within the RF spectrum have traditionally been allocated to wireless service providers subject to restrictions on the technologies that may be used and the services that may be provided. Because of this static allocation of RF spectrum, all of the RF bands are pre-allocated for specific use resulting in a lack of flexibility in spectrum allocation. An undesired by-product of such byzantine assignment methodologies is inefficient spectrum utilization and artificially created spectrum scarcity.

New paradigms for spectrum management such as dynamic spectrum access and assignment are viewed as possible methodologies for improved spectrum use. Such methodologies can accommodate the growing need of spectrum for an ever increasing number of wireless services. As a part of such efforts, spectrum management agencies such as the Federal Communications Commission (FCC) have begun issuing regulations for the promotion of efficient spectrum use supported on market-based approaches, software defined radio (SDR), and cognitive radio.

Dynamic spectrum access (DSA) is based on theoretical concepts from telecommunications engineering, wireless systems design, network information theory and mathematics to improve the performance of a communication network as a whole. DSA allows secondary radio users to examine portions of the RF spectrum that are otherwise licensed to a primary radio user. If particular segments of the RF spectrum are unoccupied by that primary user, then the secondary user can utilize the spectrum until the primary user again attempts to access the same (opportunistic DSA).

RF spectrum is not fungible; different segments of the RF spectrum are not the same. For example, various segments of the RF spectrum may be subject to one or more of wideband noise, narrowband interference, propagation, fading, and other physical phenomena to name but a few. These various forms of radio frequency interference may vary at any given moment in time and location in space. Such forms of radio frequency interference may affect some segments of the RF spectrum more than others.

In order to address these various forms of radio frequency interference, radios engaging in DSA have extensive sensing capabilities. The exception to such an approach may involve a database lookup approach based on geographical location. Database approaches ease the sensing burden since users primarily rely on spectrum records of the presence of primary users to avoid interference. The database approach is only useful in static or near static scenarios as there is no coordination amongst multiple users seeking use of spectrum resources.

There is a desire to increase the use of spectrum resources through market based mechanisms for spectrum management. As such, there is a need in the art for implementation of spectrum trading mechanisms that allow for assignment and allocation decisions to be made by market forces, which may be referred to as market-based dynamic spectrum access. There is a further need for systems and methods to help moderate an environment where buyers and sellers dynamically determine the assignment of spectrum and its uses.

### BRIEF DESCRIPTION OF THE DRAWINGS

FIG. 1 illustrates a spectrum trading scenario based on the use of a spectrum exchange.

FIG. 2 illustrates a sensor network to examine radio frequency interference in a dynamic spectrum trading exchange.

FIG. 3 illustrates the architecture of a dynamic spectrum trading exchange.

FIG. 4 is a method for implementing spectrum assignment decisions in a dynamic spectrum trading exchange.

### SUMMARY OF THE CLAIMED INVENTION

In a first embodiment, a system for implementing spectrum assignment is claimed. The system includes a plurality of network sensors that gather data concerning the RF signal power that is present at a segment of spectrum. The system further includes memory storing non-transitory computer readable instructions executable by a processor to process data gathered from the plurality of network sensors to identify the quality for one or more spectrum segments in the RF spectrum, generate a list of allowed and non-allowed spectrum assignment indicators based at least in part on the processed interference level data from the plurality of network sensors, and make a spectrum assignment decision based on the list of allowed and non-allowed spectrum assignment indicators. The system of the first embodiment further includes a radio resource manager that receives the spectrum assignment decision to generate required commands and permissions to allow for spectrum access and use by way of radio infrastructure equipment.

In a further embodiment, a method for implementing spectrum assignment is claimed. The claimed methodology includes gathering sensor data from a spectrum sensor network, aggregating sensor data gathered from the spectrum sensor network, deriving a policy, executing the policy to select specific radio resources to assign to a wireless service provider, and allowing use of the resources to the wireless service provider in accordance with the executed policy by way of a radio network infrastructure.

In some embodiments, the aforementioned methodology may be implemented in the context of computer readable instructions embodied in a non-transitory computer readable storage medium. By way of a processor or processor executing instructions embedded in such a medium, the methodology may be effectuated.

### DETAILED DESCRIPTION

The dynamic spectrum trading (DST) system described herein seeks to implement a market-based spectrum assignment mechanism. The described DST system can maximize the revenue of entities participating in a spectrum trade while enhancing the use and delivery of services in the traded spectrum. The trading of spectrum differs from the trading of traditional commodities because spectrum has a geographical area specificity that allows for its reuse in other areas. The present DST system takes into account the fact that interference from other radio frequency sources/users can diminish the value of a segment of spectrum.

While spectrum trading can enhance the efficiency and value of spectrum resources in a service area, spectrum trades should be completed only if the expected interference levels in spectrum are satisfactory for the parties involved in the trade. Dynamic spectrum assignments occurring in the context of the present DST system take into account the interference affecting spectrum segments by using capabilities to dynamically estimate and predict the interference profile in a geographical area.

Spectrum assignments under the present DST system can also consider priority-based access to the spectrum. For example, in instances of emergency/public safety certain agencies (e.g., police, fire, medical) should be given higher priority. Similar priority should be given to the military.

Spectrum awareness provides information about the availability of segments of spectrum in a given area and historical information about utilization of those segments. This information is useful for deciding the desirability of each segment and how to assign it to a potential spectrum user. The DST system of the present invention makes use of DSA methods and interference profiling to facilitate the trading of wireless spectrum based on monetary compensation such as might occur between wireless providers or urgency/priority as would be germane to public safety, military, and intra-network users.

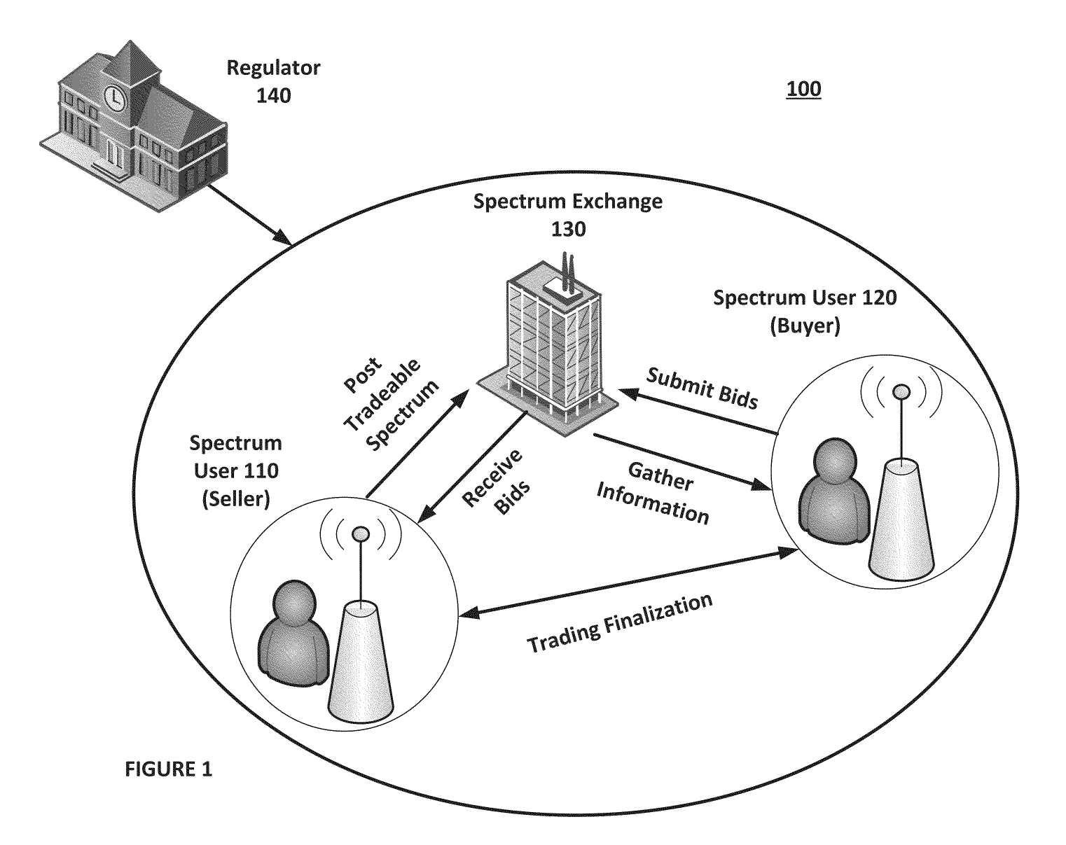

FIG. 1 illustrates a spectrum trading scenario 100 based on the use of a dynamic spectrum trading exchange. Illustrated in FIG. 1 are a spectrum user 110 and 120, spectrum exchange 130, and spectrum regulator 140.

A spectrum user might be an entity such as a wireless service provider that has a license for the use of spectrum (110). That license may be acquired either through a government led auction or a spectrum trading market. A spectrum user might also be an entity that submits a bid for spectrum licenses to the DST system with the intent of acquiring spectrum resources (120).

Spectrum exchange 130 of FIG. 1 is an entity that provides and maintains a marketplace or facilitates the bringing together of users that want to sell (110) or buy (120) spectrum. The exchange 130 may publicize pricing for spectrum and anonymize trading entities to the extent that anonymity is needed or desirable.

Also illustrated in FIG. 1 is spectrum regulator 140. A spectrum regulator may be a governmental or other administrative entity such as the FCC or Securities and Exchange Commission. Such an entity may define and enforce certain regulations concerning the operating of the exchange or the wireless spectrum in general. Spectrum regulator 140 need not be an ‘on site’ presence. The implication of certain rules and regulations promulgated by the regulator may, however, be a constant presence observed and obeyed by the aforementioned spectrum users 110 and 120 as well as exchange 130.

In the scenario illustrated by FIG. 1, the exchange 130 collects offers to sell (from sellers 110) and offers to buy (bids from sellers 120) for spectrum. The exchange 130 then determines the winning bid as might occur through, for example, the use of a continuous double-auction mechanism. Alternatively or additional, the exchange 130 may determine a winning bid through the use of data related to the radio frequency interference characteristics of the spectrum segments available for trading. The exchange 130 then transfers the right of use from a selling license holder 110 to the new owner of the spectrum rights 120. The spectrum exchange 130 of FIG. 1 may also operate as a band manager that allows trades in the form of leases on a set of managed frequencies.

The objective of spectrum trading and market-based spectrum assignment is two-fold. First, to maximize the revenue of entities participating in a trade. And second, to do so while enhancing the delivery of new services through the acquisition of spectrum resources, and satisfying the needs of the service provider customers. The spectrum exchange 130 may utilize wireless system design and game theory to predict market and competition outcomes. The spectrum exchange 130 may also employ auction-based frameworks for fine-grained spectrum assignment, profit maximization strategies and be part of a hierarchical market design.

In interference aware spectrum trading, the spectrum exchange 130 will match bids (requests to buy from spectrum users 120) and asks (requests to sell from spectrum users 110) for spectrum based on the number of units of spectrum to be exchanged and the interference level characteristics of those units. This approach addresses the complexities that exist with respect to the fact that interference characteristics of a spectrum unit vary depending on the location of the radio transceivers that will use them.

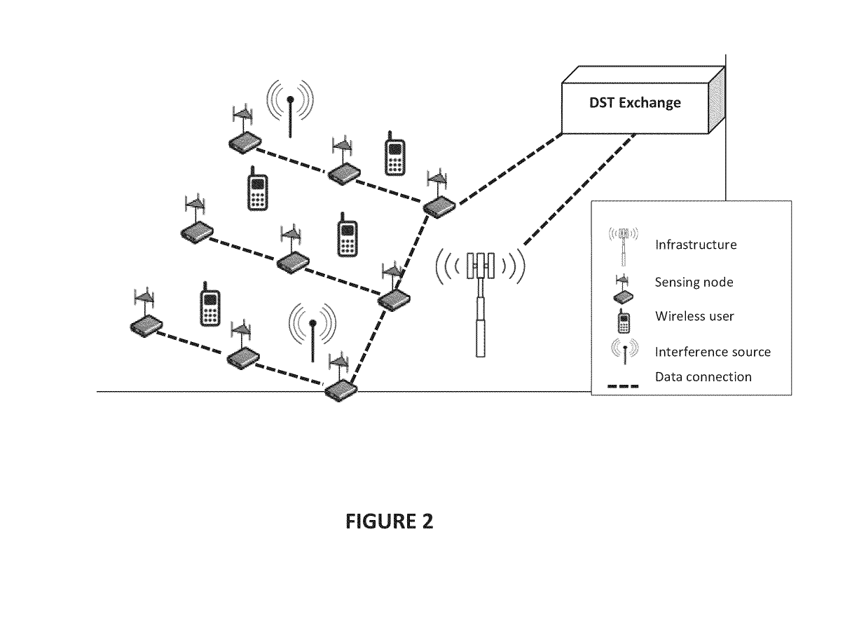

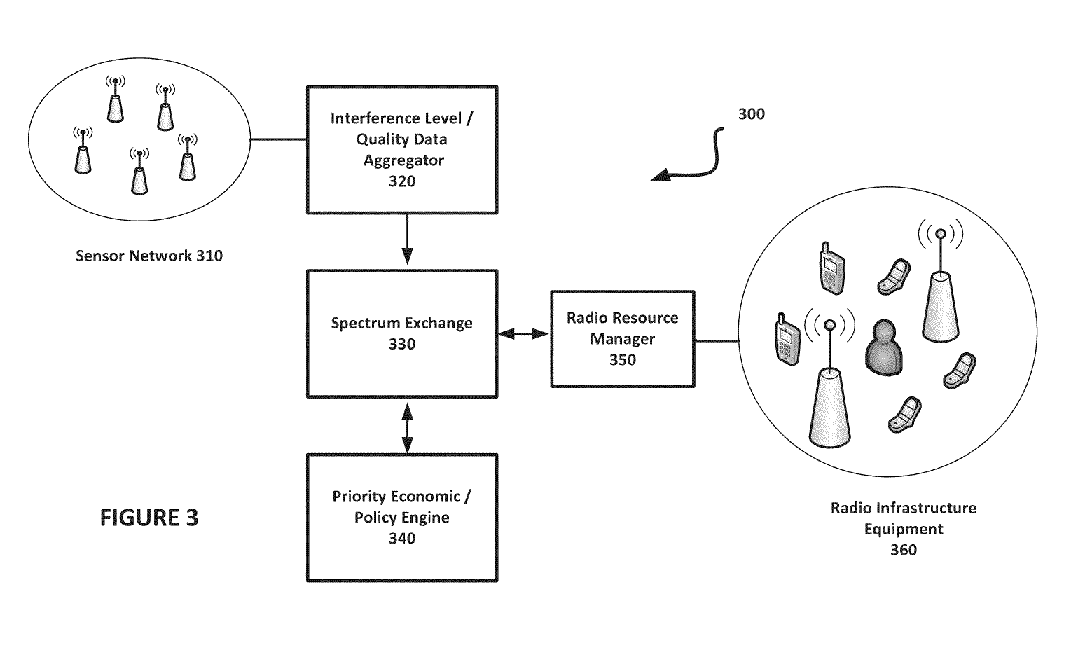

In an exemplary embodiment of the DST, the spectrum exchange 130 includes a network of spectrum sensors (illustrated in FIGS. 2 and 3) that estimate the interference level values affecting the spectrum units in a given service area. The exchange 130 uses this information to match bids and asks for spectrum. The number of spectrum sensors (sensor density) and the way that these sensors schedule and sample their measurements determines the reliability of the interference level estimations.

A variety of spectrum assignment algorithms that correspond to any variety of policies can be used by the spectrum exchange 130. These algorithms and policies are used to make a final decision as to which buyer gets a spectrum unit based on the interference characteristics and availability of spectrum resources in a service area. The use of such algorithms relates to the fact that spectrum assignment policies can affect the short-term revenue of a spectrum exchange and the spectrum efficiency of a given service area depending on how interference aware spectrum assignment decisions get executed by the logic of the exchange.

For example, the spectrum exchange 130 could operate under a policy whereby a buyer 120 submits a request for a segment of spectrum of a particular interference (quality) tier. The exchange 130 will satisfy that request if and only if the exchange 130 is able to find spectrum of the required quality as would be indicated by data acquired from a network of spectrum sensors. In addition, the request must be economically attractive to the exchange 130 in order for said request to be acted upon.

A more relaxed policy could also be used by the exchange 130. In this example, a segment of assigned spectrum is of a lower level of quality but nevertheless satisfies the economic incentives of the exchange 130 and the buyer 120. In this scenario, the buyer 120 implicitly agrees (by virtue of making a bid and understanding the policy that the exchange 130 uses or that the buyer 120 has agreed to have applied to its bids) that it is more beneficial to be able to have access to spectrum than to meet a particular quality level for the spectrum it will use in a particular moment of time. Other instantiations of policies can be used by the exchange 130 depending on availability and definitions of interference levels and economic incentives.

The DST system of the present invention may be implemented with two types of spectrum exchanges. A first embodiment may utilize a band manager (BM) exchange. A second or further embodiment may implement a non-band manager (NOBM) exchange. BM exchange based architectures may address scenarios where a contiguous spectrum band owned by a government entity or a band with previously restricted use needs to be shared with commercial users as a means to enable new wireless services, collect spectrum lease revenue and enhance spectrum efficiency considering the RF power levels (interference) present in the band. In a NOBM exchange architecture, the spectrum units that will be traded are not necessarily forming a contiguous band. The matches between bids and asks are made by mechanisms such as a continuous-double auction but take into account the interference level characteristics of the units available for trading and the required interference level requirements of the potential buyers.

The presently disclosed exchange may utilize a map of RF power levels over a given area (Radio Environment Maps (REMs)). An REM implemented in the context of the present exchange may utilize extensive field measurements and/or detailed knowledge of a geographical area. Such measurements or maps may be particularly useful in those areas where the spectral activity of interest remains relatively static. The present exchange may also use monitoring activity from transmitters that can be transient and implemented in environments that dynamically change (sometimes referred to as Dynamic RF Mapping (DRFM)).

DRFM in the context of the present exchange may utilize an interpolation method that can produce an estimate of the RF map with as few sampling points as possible but otherwise within acceptable estimation error levels. Interpolation methods that can be used for a DRFM methodology include kriging, spline-based interpolation, and Inverse Distance Weighting (IDW). The Discrete Cosine Transform (DCT) may be best suited to environments with robust changes as it maintains accuracy across a same number of sampling points. The accuracy of a given measurement estimate versus the number of sensors required to achieve such measurements may be taken into account with respect to an exchange. A DST may be implemented using an appropriate number of sensors for a desired accuracy level.

Antenna spatial diversity may be implemented in order to properly mitigate the interplay between sensors and accuracy. By combining several closely-spaced measurements into an estimate for the local average power in an area, the estimation error due to small-scale fading can be significantly reduced. This can be accomplished with a variety of different combinations of antennas, spacing distances, and number of antennas.

The implementation of a DST exchange utilizing interference profiling may include one or more market-based spectrum trading policies that take into account interference profiling information and a dynamic spectrum sensing platform that produces a radio frequency map with an interference profiling module. A spectrum exchange sub-system matches bids (requests to buy) and asks (requests to sell) for spectrum based on the number of units of spectrum to be exchanged and the desired interference characteristics desired on those units.

An interference aware spectrum exchange gathers information about the propagation effects and physical phenomena that can affect the set of spectrum units that are available for trading in a given service area. A network of spectrum sensors measures and generates future estimates of the interference levels affecting units of spectrum and uses the information to match bids and asks. The number of spectrum sensors (sensor density) and the way that they schedule and sample their measurements determines the reliability of the interference power level estimations.

In an interference aware spectrum trading environment, different types of spectrum assignment policies can be used by the spectrum exchange to make a final decision as to which buyer gets a spectrum unit based on the interference level characteristics and availability of spectrum resources in a service area. Policies that differ in the way they treat channel interference information to influence a spectrum assignment decision by the spectrum exchange may be used. Policies can enforce trades that strictly satisfy interference level demands from buyers or relax the requirement to satisfy a spectrum trade at a given level of interference based on economic incentives from or to the buyer.

Algorithms based on interference levels may also be used. These algorithms make spectrum assignments based on the interference levels and subscription level of the user. The subscription level can be generalized to priority-based assignment for cases in which there is no monetary compensation involved.

The spectrum sensing platform includes a distributed network of sensing nodes that provide information about the interference levels in a geographic area. The interference levels may be important to the operation of wireless systems and for implementing spectrum assignments. Wireless signals can change drastically over short distances and accurate estimates may require an impractical number of sensors. By utilizing algorithms that dynamically estimate the interference levels in conjunctions with maps of well-understood tradeoffs on the number of sensors and sensing errors, these environmental challenges may be overcome. The result is a reduction in the number of sensors required while maintaining an acceptable sensing error.

FIG. 2 illustrates a sensor network to examine radio frequency interference in the service area of a DST exchange. In the interference based DST exchange of FIG. 2, nine sensing nodes are illustrated. The nodes in FIG. 2 may be a mixture of low-end spectrum sensing nodes and higher-end SDR platforms. No particular configuration of nodes or type of nodes is required so long as the network of nodes collectively remain capable of sensing the wireless interference generated by wireless users and other sources.

The interference measured, sampled, or sensed by the network of FIG. 2 may be related to a particular channel or sub-carrier of the RF spectrum. Data measurements may also be inclusive of certain types of information that might be considered relevant to new or potential additional users of a segment of the spectrum, especially with respect to an economic or market based transaction. An interference profiling application programming interface (API) and signal processing algorithms that generate an RF map of the interference using the sensors deployed in an RF communications environment are used to implement the logic for an interference level/quality data aggregator.

The processing of information from spectrum sensors to profile the status of interference in a wireless service area is structured in such a way that it can feed into the processing intelligence of a spectrum exchange system or be used for policy driven radio resource management. Algorithms that allow for flexible spectrum sensing (radio environment mapping) capabilities to enhance radio resource management may provide such capabilities. The applicability of such a system extends to commercial, military and public safety environments. The system is also flexible enough to support spectrum management interactions based on economic or priority-based demands for the management and assignment of spectrum resources.

Methods for collecting and processing spectrum sensing data from sets of networked spectrum sensors provide for a robust characterization of a wireless service area. This provides greater potential to make better use of scarce spectrum resources than other DSA mechanisms that do not use this information. In addition, this information provides a radio environment map that can be used to provide historical channel condition data, signal-to-noise ratio data, and other information to other entities that will find this information valuable to make better informed decisions on their use and/or management of spectrum resources.

FIG. 3 illustrates the architecture 300 of a DST exchange. FIG. 3 as illustrated includes spectrum sensor network 310, interference level/quality data aggregator 320, DSA Coordinator/Spectrum Exchange 330, Priority Economic/Policy Engine 340, and Radio Resource Manager 350. The architecture 300 as illustrated in FIG. 3 also includes radio network infrastructure 360.

The spectrum sensor network 310 is generally akin to that described in the context of FIG. 2. Sensor network 310 may include a mixture of low-end spectrum sensing nodes and higher-end SDR platforms. In some network implementations, the sensor network 310 may be homogeneous in nature.

Interference level/quality data aggregator 320 processes data gathered from the spectrum sensor network 310. Aggregator 320 uses that data to determine the quality for the spectrum segments over which the system may operate at a given moment in time. The interference level/quality data aggregator 320, in coordination with the spectrum exchange 330, may determine the schedules for the collection of sensor data from the spectrum sensor network 310. The interference level/quality data aggregator 320 also provides radio environment mapping capabilities that can be used by the Spectrum Exchange 330.

DSA Coordinator/Spectrum Exchange 330 includes the logic to communicate with the other components of the DST exchange architecture 300. Coordinator/Exchange 330 also integrates the information provided by these various components to make dynamic spectrum assignment decisions based on any combination of RF power measurements, priority, and economic parameters such as those discussed in the context of FIG. 1. Such parameters may be defined by the policy engine 340. The Coordinator/Exchange 330 ultimately selects specific radio resources to assign to a wireless service operator in coordination with the radio resource manager 350.

Priority Economic/Policy Engine 340 processes priority based and economic based spectrum access policies. Policy Engine 340 generates a list of allowed and non-allowed spectrum assignment indicators that are used to make radio resource assignment decisions. While FIG. 3 illustrates the functionality of exchange 330 and engine 330 as being distinct, some embodiments of the DST system may integrate those functionalities within a single entity.

Radio resource manager 350 receives radio resource assignment decision information from coordinator 330. Resource manager 350 uses decision information to generate the required command and/or permission information to be sent to radio infrastructure equipment 360 and any associated infrastructure providers. Manager 350 does so to activate a specific radio resource or channel for use by a wireless service operator that has interacted with the DST exchange architecture 300 of FIG. 3.

Radio network infrastructure 360 is inclusive of the universe of equipment necessary to access the RF spectrum. An example of such infrastructure includes base station equipment. Base station equipment is further inclusive of receivers, transmitters, and/or transceivers, encoders and decoders, and a power supply. Antenna and tower equipment may also be a part of a base station implementation. Network infrastructure 360 may further include a network of repeaters or other transmission/retransmission towers as well as any variety of wireless access devices that might be present in a particular network or cell of a network.

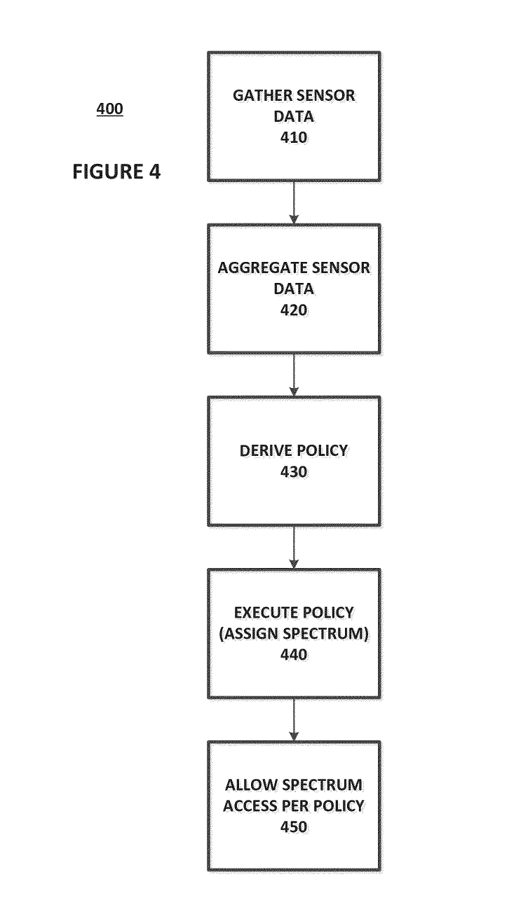

FIG. 4 is a method 400 for implementing spectrum assignment decisions in a DST exchange. In step 410 of method 400, spectrum sensor data is gathered from a spectrum sensor network. This data is ultimately used to determine the quality for various spectrum segments. Sensor data may be gathered from a sensor network like that illustrated in FIG. 2 and FIG. 3 (310).

In step 420, the sensor data gathered in step 410 is aggregated. Aggregation of sensor data may occur through the execution of an interference level/quality data aggregator like that described in the context of FIG. 3 (interference level/quality data aggregator 320). As a part of step 410, data gathered from a spectrum sensor network like that illustrated in FIG. 2 and FIG. 3 (310) is used to determine the quality of service levels from various spectrum segments. Sensor scheduling and radio environment mapping may also take place in step 420.

One or more policies are derived in step 430 of FIG. 4. Derivation of a policy may occur through execution of a priority or economic policy engine like that described in FIG. 3 (340). Policies may include one or more of a priority policy such as emergency or military needs as well as economic parameters such as spectrum bidding as discussed in the context of FIG. 1. Policy application in step 430 may take into account a combination of such factors whereby an economic policy such as a winning spectrum bid is trumped by an unplanned emergency event.

Execution of a policy occurs at step 440 of FIG. 4. In step 440, the application of the derived policy of step 430 comes to fruition whereby the likes of a DSA coordinator/spectrum exchange such as that of element 330 in FIG. 3 integrates the quality, priority, and economic aspects of a policy decision to select specific radio resources to assign to a wireless service provider in conjunction with a radio resource manager like that of element 350 and described in FIG. 3.

In step 450, network access is allowed as a result of the spectrum assignment that took place in step 440. The spectrum resource assignment decision is provided to radio infrastructure equipment and related providers to allow for spectrum access subject to any limitations or requirements of the aforementioned policy.

One skilled in the art will appreciate the reference to various APIs, engines, instructions, or other executable components as described above. One skilled in the art will likewise appreciate that these various functionalities or methodologies may be implemented in the context of computer-readable instructions. Those instructions may be stored in a non-transitory computer readable storage medium such as memory. Those instructions may be executed by a processor or series of processing devices which may be local or distributed; the same may be said of the storage of said instructions. Various other computer and networking components will be known to one of skill in the art for the purpose of receiving and transmitting those instructions, storing said instructions, and otherwise effectuating the same.

The foregoing detailed description has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

What is claimed is:

1. A system for implementing spectrum assignment, the system comprising:
a plurality of network sensors that gather data concerning the RF signal power in a segment of spectrum in the RF spectrum;
memory storing non-transitory computer readable instructions executable by a processor to:
process data gathered from the plurality of network sensors to identify the quality for one or more spectrum segments in the RF spectrum,
generate a list of allowed and non-allowed spectrum assignment indicators based at least in part on the processed quality data from the plurality of network sensors, and
make a spectrum assignment decision based on the list of allowed and non-allowed spectrum assignment indicators; and
a radio resource manager that receives the spectrum assignment decision to generate required commands and permissions to allow for spectrum access and use by way of radio infrastructure equipment.

2. The system of claim 1, wherein the data concerning RF signal power includes data related to radio frequency interference.

3. The system of claim 2, wherein the radio frequency interference is wideband noise.

4. The system of claim 2, wherein the radio frequency interference is narrowband interference.

5. The system of claim 2, wherein the radio frequency interference includes the effects of signal propagation.

6. The system of claim 2, wherein the radio frequency interference concerns includes the effects of signal fading.

7. The system of claim 1, wherein the data concerning RF signal power includes information related to a particular channel.

8. The system of claim 1, wherein the data concerning RF signal power includes information related to a sub-carrier.

9. A method for implementing spectrum assignment, the method comprising:
gathering sensor data from a spectrum sensor network;
aggregating sensor data gathered from the spectrum sensor network;
deriving a policy;
executing the policy to select specific radio resources to assign to a wireless service provider; and
allowing use of the resources to the wireless service provider in accordance with the executed policy by way of a radio network infrastructure.

10. The method of claim 9, wherein the sensor data includes data used to determine the quality of various spectrum segments.

11. The method of claim 9, wherein the aggregation of sensor data includes sensor scheduling.

12. The method of claim 9, wherein the aggregation of sensor data includes radio environment mapping.

13. The method of claim 9, wherein the policy is priority based.

14. The method of claim 13, wherein the priority based policy involves emergency spectrum access.

15. The method of claim 13, wherein the priority based policy involves military access to spectrum.

16. The method of claim 9, wherein the policy is economically based.

17. The method of claim 16, wherein the economically based policy involves spectrum bidding.

18. The method of claim 16, wherein the economically based policy is subject to a priority based policy.

19. The method of claim 9, wherein the policy is quality based.

20. A non-transitory computer readable storage medium having embodied thereon instructions executable by a processor to perform a method for implementing spectrum assignment, the method comprising:
gathering sensor data;
aggregating sensor data;
deriving a policy;
selecting specific radio resources to assign to a wireless service provider; and
allowing network access to the wireless access service provider in accordance with the policy.
